(19) United States
(12) Patent Application Publication
(10) Pub. No.: US 2007/0260614 A1
(43) Pub. Date: Nov. 8, 2007

(54) LOCK-FREE IMPLEMENTATION OF AN ORDERED SINGLE-WRITER MULTIPLE-READERS DATA STRUCTURE

(75) Inventor: Tim Bray, Vancouver (CA)

Correspondence Address: Sun Microsystems, Inc.;c/o DARBY & DARBY P.C., P.O. BOX 770, Church Street Station, NEW YORK, NY, 10008-0770, US

(73) Assignee: Sun Microsystems, Inc., Santa Clara, CA (US)

(21) Appl. No.: 11/381,285

(22) Filed: May 2, 2006

(51) Int. Cl. G06F 7/00

(52) U.S. Cl. 707/100

(57) ABSTRACT

A lock-free implementation of an ordered data structure allows updating of the data structure without disturbing the ordering relied upon for accessing the data structure. After searching and finding an element in a data structure in accordance with an update operation (i.e., an insert operation or a remove operation), values are successively copied to shift the values either up or down the data structure. If an insert operation is being performed, then the new value is eventually inserted to overwrite a duplicate value in the data structure. If a delete operation is being performed, then a value is shifted over the value to be deleted.

### BACKGROUND

1. Field of the Invention

The invention relates to lock-free updating of data structures, and, more specifically, to lock-free updating of a searchable ordered data structure with a single writer and multiple readers.

2. Description of the Related Art

A data structure that is concurrently accessed (e.g., by multiple threads, multiple processing units, etc.) requires a mechanism or technique to maintain integrity of the data. Locking implementations of data structures are utilized to accomplish data integrity. However, the overhead from locking that is incurred may be undesirable in particular environments or applications. With very heavily accessed lists, such as in an online application experiencing high transaction rates, the overhead is significantly expensive. To avoid the locking overhead, lock-free implementations of data structures have been proffered. Such lock-free implementations employ primitives, such as compare-and-swap or double compare-and-swap, which are expensive primitives and/or may not be supported by some platforms.

### SUMMARY

It has been discovered that shifting values of an ordered data structure with successive copying of values achieves a lock-free searching and update of the data structure for an update operation that employs order dependent searching. In a single-writer multiple-readers data structure with ordered values, the writer shifts by successively copying elements from an end of the data structure to a target of an update operation. If the update is a removal operation, then the successive copying overwrites the target. If the update operation is an insert operation, then the resident values are shifted to accommodate the value to be inserted. Eventually, the insert operation overwrites a duplicate value in the data structure with the value of the insert operation. The successive copying of elements in a single-writer multiple-reader data structure, which employs order dependent searching, to implement a lock-free update allows realization of an inexpensive lock-free data structure implementation.

### BRIEF DESCRIPTION OF THE DRAWINGS

The present embodiments may be better understood, and its numerous objects, features, and advantages made apparent to those skilled in the art by referencing the accompanying drawings.

FIG. 1 depicts an example flowchart for lock-free insert of a value into an ordered data structure.

FIG. 2 depicts shifting of values in a data structure to insert a value ‘26’.

FIG. 3 depicts a flowchart for lock-free removal of a value from an ordered data structure.

FIG. 4 depicts an example data structure as values are copied to shift down for a remove operation.

FIG. 5 depicts an example computer system.

The use of the same reference symbols in different drawings indicates similar or identical items.

### DESCRIPTION OF EMBODIMENT(S)

The description that follows includes exemplary systems, methods, techniques, instruction sequences and computer program products that embody techniques of the present invention. However, it is understood that the described invention may be practiced without these specific details. For instance, the depicted examples refer to a data structure that resembles an array, but the lock-free implementation may also be implemented on other data structures, such as a linked list, vector, etc. In other instances, well-known protocols, structures and techniques have not been shown in detail in order not to obscure the invention.

The following description includes the term “element.” An element corresponds to a unit of a particular data structure. If a data structure is an array, then the element is a location in the array. If the data structure is a linked-list, then an element of the linked-list is a node. An element can be added to a static array by incrementing a value indicating number of units of the array with active values. An element can be added to a linked-list by creating a new node and adding a pointer to that new node. Although numerous examples are available, describing the plethora of data structures and corresponding implementations is avoided to prevent obfuscating the described invention.

Update operations that access a data structure include add/insert operations and remove/delete operations. Shifting values with successive copying allows a value to be inserted or added to a heavily accessed list (e.g., an array, vector, linked list, etc.) without locking the list. Locking is not necessary because copying to shift the values of the ordered array does not disturb the ordering relied upon by the search.

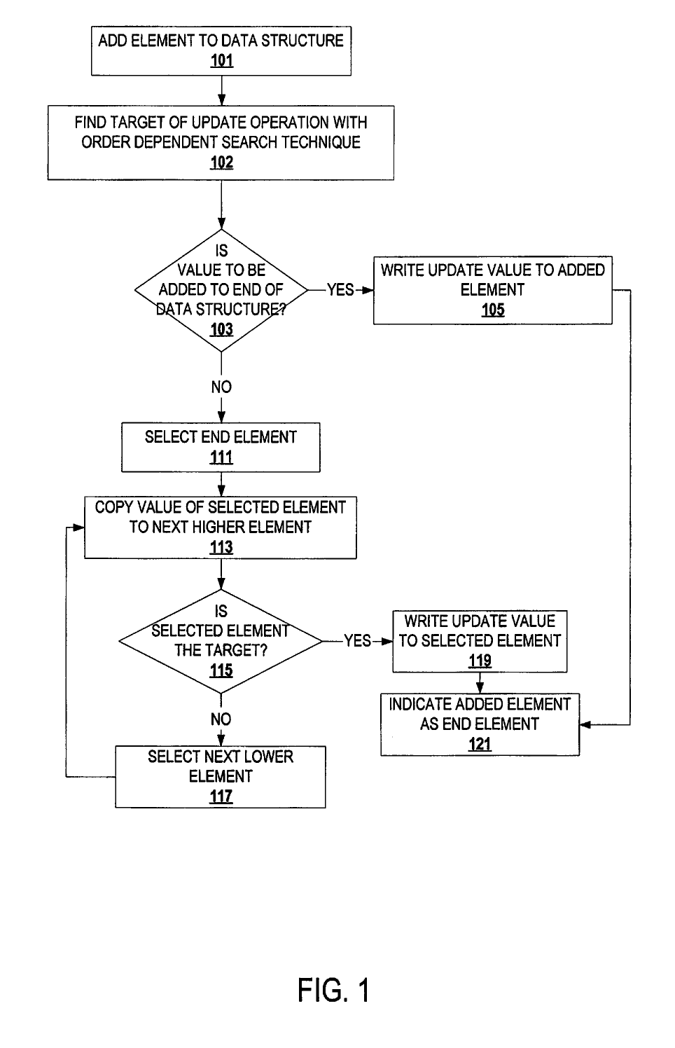

FIG. 1 depicts an example flowchart for lock-free insert of a value into an ordered data structure. At block 101, an element is added to a data structure. Adding an element can be realized in a number of different ways, depending upon the data structure. For example, if the data structure is an array, then the element would be added by indicating an increase in the number of values resident in the array. In another example a node is added to a linked-list or a pointer is updated. Every realization for adding an element to a data structure is not described to avoid obfuscating the described embodiments. At block 102, the target in the data structure (e.g., position in the data structure for inserting the value) is found in accordance with order dependent searching. At block 103, it is determined whether the added element is the target (i.e., whether the value is to be inserted at the end of the data structure). If the target is the added element, then control flows to block 105. If the target is not the added element, then control flows to block 111.

At block 105, the update value is written to the added element. Control flows from block 105 to block 121.

At block 111, an end element of the data structure is selected. At block 113, a value at the selected element is copied to a next higher element. At block 115, it is determined whether the selected element is the target element. If the selected element is the target element, then control flows to block 119. If the selected element is on the target element, then control flows to block 117.

At block 117, the next lower element is selected. Control flows from block 117 back to block 113.

At block 119, the update value is written to the selected element. At block 121, the added element is now indicated as the end element.

The following is example code for finding a target element and then lock-free inserting of a value. The findPos function finds a position in an array for inserting the value key. The function add inserts the value pair at the position in the array indicated by findPos.

private int findPos(Comparable key)

{

int high = used, low = −1;
while (high − low > 1)
{

int probe = (high + low) / 2;
if (key.compareTo(p[probe].key) > 0)

low = probe;

else

high = probe;

}
return high;

}

public boolean add(Pair pair)

{

int pos = findPos(pair.key);
if (pos < used && pair.key.compareTo(p[pos].key) == 0)

return false;

if (pos < used)
{

p [used] = p [used − 1];
used++;
for (int i = used − 2; i > pos; i−−)

p[i] = p[i − 1];

}
else

used++;

p[pos] = pair;
return true;

}

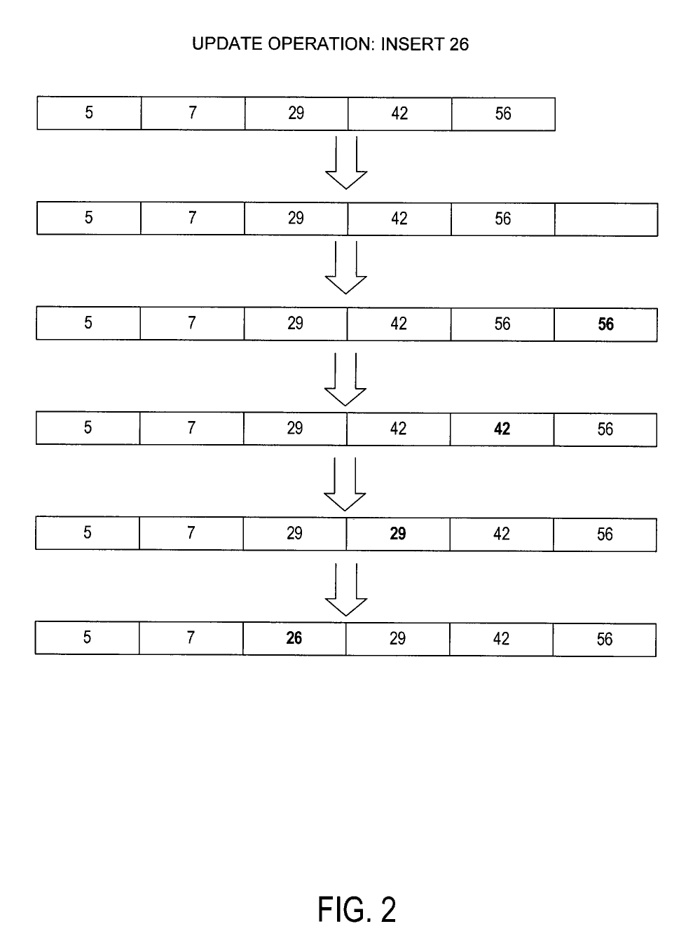

FIG. 2 depicts shifting of values in a data structure to insert a value ‘26’. A data structure depicts an ordered data structure with the following values: 5, 7, 29, 42, and 56. An element is added to the data structure. The addition of the element may simply be an increment of an indication of the number of used elements in an array (i.e., the element already existed but was not being used). After the addition of the element, the topmost value ‘56’, which resides at an end element, is copied to the added element. The value ‘42’ is then copied to overwrite the old ‘56.’ The update operation then copies the value ‘29’ over the old value ‘42.’ Finally, the update operation writes over the old value ‘29’ with the value ‘26.’ An entity (e.g., thread) reading the data structure may encounter a duplicate value, the duplicate value does not disturb the ordering.

Implicit in this procedure is an assumption that there is space available in the data structure to copy the topmost element up one position. If this is not the case, the data structure will have to be adjusted to bring it into a state that makes the case true. For example, if the data structure is organized into pages, and the page to be updated is full, then an embodiment would split the full page into two half-full pages. The add operation can now operate on the two half-full pages. Of course, it is not necessary for such an adjustment to result in two half-full pages. The adjustment may result in any of a range of redistributions of the data structure over multiple pages (e.g., ⅔ on a first page and ⅓ on a second page, ⅓ over three pages; etc.). Although this adjustment of the data structure may involve locking, such locking would be infrequent.

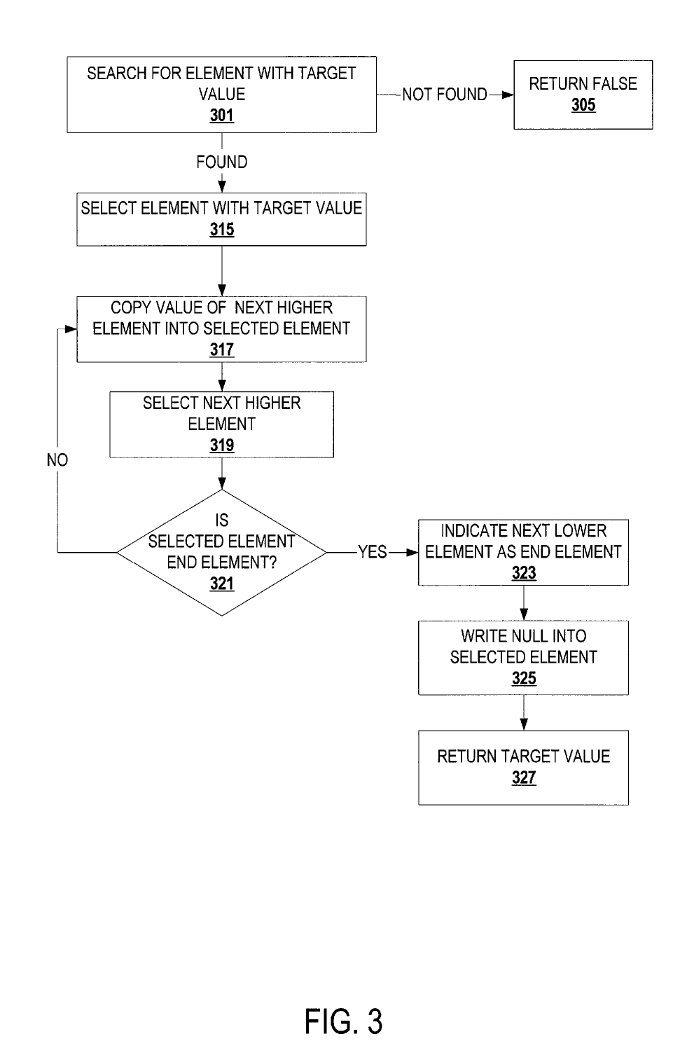

FIG. 3 depicts a flowchart for lock-free removal of a value from an ordered data structure. At block 301, the update operation searches for an element with a target value (e.g., binary search). If an element is found with the target value, then control flows to block 315. If an element is not found with the target value, then control flows to block 305.

At block 305, false is returned to indicate that the value was not found in the data structure.

At block 315, the element with the target value is selected. At block 317, a value at a next higher element is copied into the selected element. At block 319, the next higher element is selected. At block 321, it is determined whether the selected element is an end element. If the selected element is not the end element, then control flows back to block 317. If the selected element is the end element, then control flows to block 323. At block 323, the next lower element, with respect to the selected element, is indicated as the end element. At block 325, a null value is written into the selected element. The writing of a null value is for illustrative purposes. Various embodiments may or may not write a null value. At block 327, the target value is returned. Those of ordinary skill in the art should realize that it is not necessary to return the target value or a false. A removal (and insert) operation can be implemented with any of a variety of techniques to indicate whether the operation has failed or succeeded.

The following is example code for implementing a lock-free remove operation on an ordered array. As in the above example add code, the function findPos returns an indication of a position in an array for the remove operation. If key was not found in the array, then false is returned. Otherwise, values are successively copied to implement a shift down into the position of the array that hosted key. Finally, a null value is written into the previous end position.

public boolean remove(Comparable key)

{

int pos = findPos(key);
if (pos == used | | key.compareTo(p[pos].key) != 0)

return false;

for (int i = pos; i < used − 1; i++)

p[i] = p[i + 1];

used−−;
p[used] = null; // so it can be garbage-collected
return true;

}

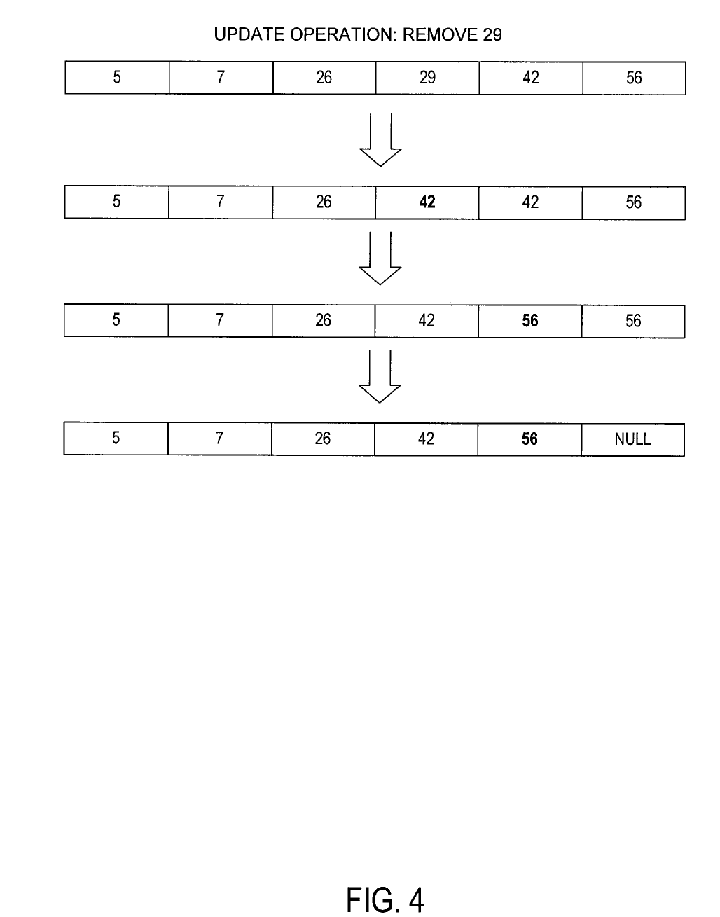

FIG. 4 depicts an example data structure as values are copied to shift down for a remove operation. Assume an operation to remove a value ‘29’ is performed upon the depicted data structure, which includes the values 5, 7, 26, 29, 42, and 56. The value ‘42’ is copied over the value ‘29.’ The value 56 is then copied over the old duplicate value ‘42.’ Finally, ‘NULL’ is written into the end element that hosted the value ‘56.’ However, it is not necessary for ‘NULL’ to be written into an old end element. The element may be reset to host ‘0’ or simply unchanged. If the element becomes used again, then the stale value will be overwritten. Again, the insert is performed lock-free and without disturbing ordering replied upon by other entities that may be searching and reading the data structure.

As with the insert, the data structure may be adjusted to compensate for a remove operation that results in the data structure occupying less space. For example, if the data structure is organized into pages, as in the above example, then the data structure can be adjusted to occupy fewer pages. Embodiments may vary as to when the data structure should be adjusted. For example, the data structure may be adjusted when the data structure occupies less than some percentage of the pages currently allocated to the data structure, when a page becomes empty, etc.

The described embodiments may be provided as a computer program product, or software, possibly encoded in a machine-readable medium as instructions used to program a computer system (or other electronic device) to perform a process in accordance with embodiments described herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, optical, acoustical or other form of propagated signal (e.g., carrier waves, infrared signals, digital signals, etc.); or other types of medium suitable for storing electronic instructions.

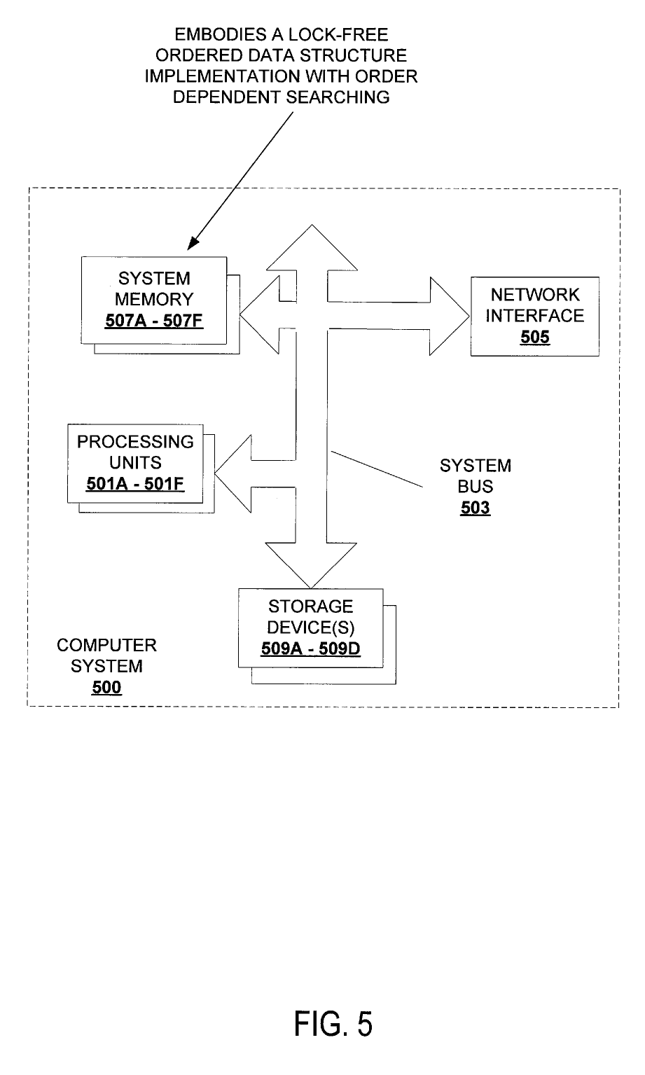

FIG. 5 depicts an example computer system. A computer system 500 includes processing unit(s) 501 (e.g., single processing unit, multiple cores on a single chip, multiple cores on multiple chips, etc.). The computer system 500 also includes a system memory 507A-507F. The system memory may include one or more of cache, SRAM, DRAM, RDRAM, EDO RAM, DDR RAM, EEPROM, etc.). The computer system 500 further includes a system bus 503 (e.g., LDT, PCI, ISA, etc.), a network interface 505 (e.g., an ATM interface, an Ethernet interface, a Frame Relay interface, etc.), and a storage device(s) 509A-509D (e.g., optical storage, magnetic storage, etc.). Realizations may include fewer or additional components not illustrated in FIG. 5 (e.g., video cards, audio cards, additional network interfaces, peripheral devices, etc.). The system memory 507A-507F embodies an ordered data structure implementation for lock-free updating that relies on order dependent searching. All or a portion of the described functionality for lock-free inserts and removes may be embodied in the system memory 507A-507F. At least some of the functionality may be implemented in the processing unit 591 and/or a co-processing unit not depicted.

While the invention has been described with reference to various realizations, it will be understood that these realizations are illustrative and that the scope of the invention is not limited to them. Many variations, modifications, additions, and improvements are possible. For instance, some of the depicted examples access data structures with indices. However, data structures may be accessed with other techniques, such as via pointers. More generally, realizations in accordance with the present invention have been described in the context of particular realizations. These realizations are meant to be illustrative and not limiting. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

What is claimed is:

1. A method for performing a lock-free update operation on an ordered single-writer multiple-reader data structure, the method comprising:
successively copying values of the data structure to shift the values in accordance with the lock-free update operation while preserving order of the values,
wherein the copied values are those values resident in the data structure from an element indicated as an end of the data structure to an element targeted by the update operation, wherein access to the data structure employs order-dependent searching.

2. The method of claim 1 further comprising order dependent searching of the data structure for a value targeted by the update operation.

3. The method of claim 1 further comprising adding an element to the data structure and indicating the added element as the end of the data structure.

4. The method of claim 3, wherein an adding an element comprises one of adding a node and incrementing a value that indicates available elements in the data structure.

5. The method of claim 3, wherein the successively copying comprises:
successively selecting each element from the added element to the target element; and
for each selected element,
if the currently selected element is the target element, then writing a value of the update operation to the currently selected element;
if the currently selected element is not the target element, then copying a value from an adjacent element toward the target element to the currently selected element.

6. The method of claim 5 further comprising reorganizing the data structure over multiple pages if a current state of the data structure is insufficient to accommodate the update operation.

7. The method of claim 1, wherein the successively copying implements a delete operation comprising:
successively selecting each element from the target element to an element adjacent to the element indicated as the end of the data structure, for each selected element, copying a value at an adjacent element toward the end to the currently selected element.

8. The method of claim 7 further comprising writing a null value into the indicated end element.

9. The method of claim 8 further comprising indicating the element adjacent to the indicated end element toward the target element as the end element.

10. The method of claim 1, wherein the data structure comprises one of a linked-list and an array.

11. A computer program product encoded in one or more machine-readable media, the computer program product comprising:
a first sequence of instructions executable to shift values of an ordered single-writer multiple-reader data structure with copy operations to implement a lock-free update operation on the data structure,
wherein the first sequence of instructions shifts those values resident in the data structure at a target element that corresponds to the update operation to an indicated end element of the data structure, wherein access to the data structure relies on order dependent searching.

12. The computer program product of claim 11 further comprising a second sequence of instructions executable to implement the order dependent searching.

13. The computer program product of claim 12, wherein the order dependent search comprises binary search.

14. The computer program product of claim 11, wherein the first sequence of instructions are further executable to add an element to the data structure.

15. The computer program product of claim 14, wherein the first sequence of instructions being executable to shift to implement the update operation comprises:
the first sequence of instructions executable to,
for each element from the added element to the target element,
if a current element is the target element, then copy a value of the update operation to the current element,
if the current element is not the target element, then copy a value at an adjacent element toward the target element to the current element.

16. The computer program product of claim 11, wherein the first sequence of instructions being executable to shift to implement the update operation comprises:
the first sequence of instructions executable to,
for each element from the target element to an element adjacent the indicated end element,
copy a value at an element adjacent a current element toward the indicated end element to the current element.

17. An apparatus comprising:
a shared memory; and
means for utilizing copy operations to shift values of an ordered single-writer multiple-reader data structure in accordance with a lock-free update operation on the data structure, which is encoded in the shared memory,
wherein access to the data structure employs order dependent search.

18. The apparatus of claim 17,
wherein the shift of values results in a duplicate of one of the values at an element of the data structure targeted by the update operation,
wherein a first of the duplicate values is overwritten with a value of the update operation in accordance with ordering of the values.

19. The apparatus of claim 17, wherein the shift of values results in a value targeted by the update operation being overwritten and updating an end element indication to reflect deletion of the overwritten value.
